(19) United States
(12) Patent Application Publication
(10) Pub. No.: US 2003/0064633 A1
(43) Pub. Date: Apr. 3, 2003

(54) Support section for an electrical contact

(75) Inventor: Kenny Padro, Hamden, CT (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Litton System, Inc.

(21) Appl. No.: 10/186,633

(22) Filed: Jul. 2, 2002

Related U.S. Application Data
(63) Continuation of application No. 09/965,869, filed on Oct. 1, 2001.

(51) Int. Cl. H01R 13/514

(52) U.S. Cl. 439/752

(57) ABSTRACT

The present invention is directed to an electrical contact having a compliant section. The electrical contact has a primary section retained within an electrical contact. The electrical contact has a secondary section that includes an elongated section, a compliant section and a support section. The support section is formed such that when the compliant section is inserted into a hole in a PC board, the elongated section remains straight within a wide range of manufacturing tolerances.

### RELATED APPLICATION

The present application is related to a patent application entitled “COMPLIANT SECTION FOR AN ELECTRICAL CONTACT” and assigned to the instant assignee and filed on Oct. 1, 2001, Ser. No. 09/965,869, and is hereby incorporated by reference into this specification in its entirety.

### FIELD OF THE INVENTION

The present invention relates generally to the field of electrical connectors, and more particularly, to an electrical contact for an electrical connector. More particularly, the present invention relates to an electrical contact having a support section to support a compliant section for insertion into a PC board.

### BACKGROUND OF THE INVENTION

Modern electronic systems continue to demand higher density, higher speed and more cost-effective packaging in interconnection solutions. For example, Winchester Electronics markets a series of connectors called MetCon-2® 2 mm hard metric connector systems. These types of connectors have multiple contacts sometimes arranged in 5×5 matrices which are tightly spaced together. These types of connectors are described in greater detail in a catalog entitled “Winchester MetCon-2® 2 mm Hard Metric Connector”, incorporated herein by reference.

As depicted in FIG. 1A a prior art contact 10 is depicted. The contact 10 includes a primary portion 12 which is inserted into one-half of an electrical connector (see FIG. 3). The primary portion 12 is retained within the electrical connector in a conventional manner and a secondary portion 14 extends outwardly beyond the electrical connector for insertion into corresponding holes in a PC board. The secondary portion 14 includes a compliant portion 16 and an elongated pin portion 18. The compliant portion 16 has opposed rounded outer surfaces 20 and a cat's eye shaped central opening 22. The difficulty with the prior art compliant portion 16 is illustrated in FIG. 1B.

In FIG. 1B, the compliant portion 16 is inserted into a plated through hole 28 illustrated in FIG. 2. When each contact 10 is inserted into a through hole 28, there is a tendency for some or all of the elongated sections 14 to tip at an angle as illustrated in FIG. 1B. Because of the length of each of the elongated sections 14 and because of the tight spacing between these contacts 10, it is very important that the secondary side 14 of the contacts remain straight without tipping in order to be inserted into a mating connector. This problem is exacerbated by the fact that these contacts are closely spaced and, for example, a matrix of 5×5 array, there is a high likelihood of stubbing one or more of the contacts when an electrical connector is mated to the elongated sections 14. When an elongated section 14 is stubbed, the pin 14 is crushed and of course no signal can be carried by the pin.

The cause of the tipping is due to the compliant portion 16. If the cat's eye opening 22 is slightly off center due to manufacturing tolerances by as little as 0.0005 inches, then unequal forces are created on the compliant portion 16 as illustrated in FIG. 1B when the each contact is pressed into a through hole 28. When the compliant portion 16 is inserted into the hole 28, the purpose of the compliant portion 16 is to maintain a holding force. Referring to FIG. 1B, there are two curved beam sections 24, 26 on opposing sides of compliant portion 16. If one of the two beams 24, 26 is slightly thinner than the other beam then it is likely that tipping will occur.

Accordingly, a need exists for a contact which can be inserted into a round hole which will stay straight and not tip within a wide zone of manufacturing tolerances.

### SUMMARY OF THE INVENTION

It is therefore, an object of the present invention to provide an electrical contact having a support section which supports the compliant section so that the elongated section will not tip significantly when inserted into a hole in a PC board within a wide range of manufacturing tolerances.

The present invention is directed to an electrical contact having a support section for supporting the compliant section. The electrical contact has a primary section retained within an electrical contact. The electrical contact has a secondary section that includes an elongated section and a compliant section. The compliant section, the support section is formed such that when the compliant section is inserted into a hole in a PC board, the compliant section and the elongated section remain straight within a manufacturable range of manufacturing tolerances.

These and other objects of the present invention are achieved by a contact for insertion into a hole in a PC board including a contact body including an engagement portion for engagement with an electrical connector body. The contact body has an elongated section, a compliant section and a support section connecting the elongated section and the compliant section. The support section has a larger cross-section than the elongated section.

The foregoing and other objects of the present invention are achieved by an electrical connector including a body for receiving a plurality of electrical contacts. Each of the electrical contacts has a contact body including an engagement portion for engagement with an electrical connector body. The contact body has an elongated section, a compliant section and a support section connecting to the elongated section and the complaint section. The support section has a larger cross-section than the elongated section.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1A is an illustration of a prior art electrical contact;

FIG. 1B is an illustration of a prior art contact with the elongated section having tipped after being inserted into a through hole;

FIG. 2 is a partial cross-sectional view of a through hole;

FIG. 3 is an illustration of a prior art electrical connector having the prior art electrical contacts illustrated in FIG. 1A;

FIG. 4 is an illustration of a prior art contact depicting the compliant portion in greater detail;

FIG. 5A is an enlarged view illustrating the support section according to the present invention; and

FIG. 5B is a cross-sectional view taken along line 5B-5B in FIG. 5A;

FIG. 5C is a cross-sectional view taken along line 5C-5C in FIG. 5A; and

FIG. 5D is an enlarged view from FIG. 5A of the support section according to the present invention.

### DETAILED DESCRIPTION OF THE INVENTION

Referring first to FIG. 5A, the present invention is directed to a support section of a pin type electrical contact 400. The present invention is particularly advantageous when used with an elongated contact section to prevent the elongated pin portion 18 from tipping.

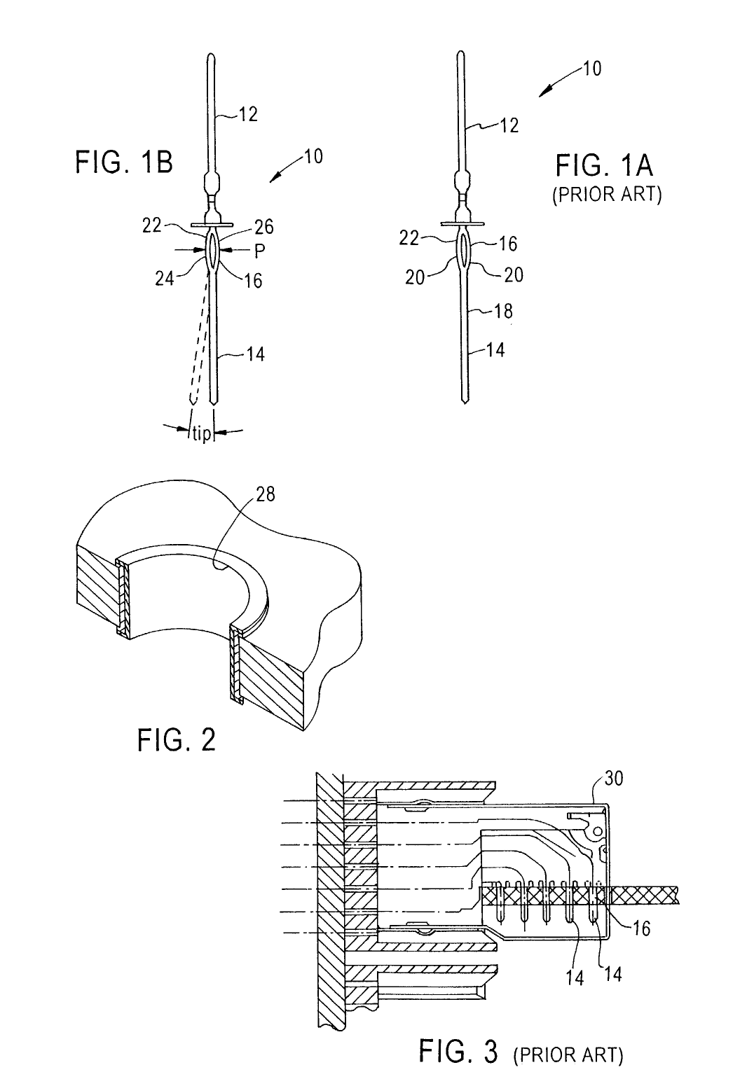

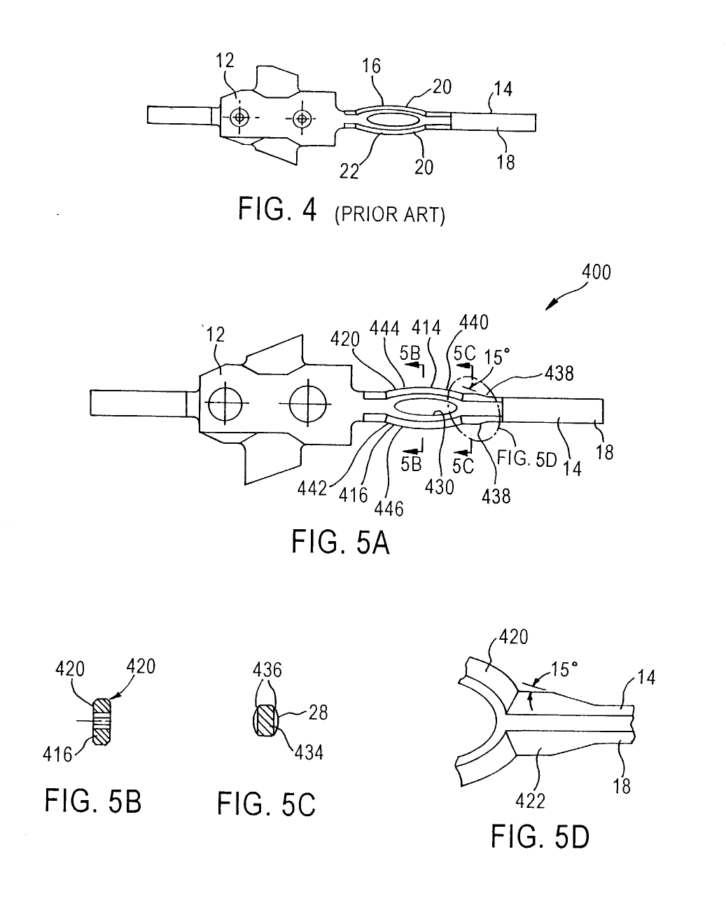

The electrical contact 400 of the present invention is similar to the contact illustrated in FIGS. 1A and 4 except for the compliant section 420 and the support section 422. As illustrated in FIG. 4A, the compliant section 420 is connected to the elongated pin portion 18 by the support section 422. The contact 400 can have any type of primary section 12 as illustrated in FIGS. 1A, 4 and 5A, as known to those of skill in the art. Similarly, the elongated section 18 can vary in length. It is customary in various applications to have sequential electrical contact and thus within any given electrical connector it is quite possible to have elongated sections 18 of different lengths. The compliant section 420 has two beams 440, 442 each having rounded outer surfaces 444 and 446, respectively, each having a width, at the widest point, which is larger than the diameter of the plated through hole 28. Of course, the dimensions can vary depending on the size of the plated through hole and the size of the contact. There is a central largest hole 430 with a cat-eye shape which has a centerline coincident with the longitudinal access of the electrical contact and a horizontal center line which should be coincident with the widest portion of compliant section 420. The hole 430 forms two beams 440, 442 which are spaced apart by approximately 0.010 and are each approximately 0.010 inches thick. The length of each beam is approximately 0.057 long and has approximately the same radius. The support section 422 ends away from one end of the compliant section 420 and is the same width as the compliant section 420 at its smallest width and the other end of the 420 compliant section, the width is the same width of the elongated section 18.

As depicted in FIG. 1B, when the compliant section 420 is inserted into the plated through hole 28, forces P, a horizontal force is applied to the compliant section 420 along surfaces 16 and 20, respectively. The forces P tend to elongate the compliant section 420 thereby reducing the width. Advantageously, when the elongated section 18 is inserted into the plated hole, the support section 422 has a width slightly larger than the plated hole 28. As depicted in FIG. 5B, each of the beams 440, 442 has rounded edges for contact with the plated hole 28. Similarly, as depicted in FIG. 5C, the support section 442 has rounded corners 436. Also, the support section 422 has entry ramp 438 which first makes contact with the plated through hole 28. The rounded corners 436 make contact with the plated through hole as depicted in FIG. 5C. The ramp 438 has a 15° lead in angle. The purpose of the compliant section 420 is to maintain a holding force when inserted into the PC board hole 28. When the contact and the compliant section 420 are pressed into the PC board hole 28, an even force (illustrated by P) is applied to the beams 440, 442 of the compliant section 420. The support section 422 serves to strengthen the compliant section 420 due to the added compression needed to buckle the beams 440, 442. The result is the uniform elongation of the compliant section 420, hence, eliminating any tilting that would have occurred due to the non-linear compression of both compliant beams.

The contact is preferably stamped from an alloy C5100 phosphorous bronze and is approximately 0.015 inches thick.

It should now be apparent that a support section for an electrical contact has been described in which the support section can be inserted into a through hole in a PC board and yet the elongated section remains straight.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A contact for insertion into a hole in a PC board, comprising:
a contact body including an engagement portion for engagement with an electrical connector body;
said contact body having an elongated section, a compliant section and a support section connecting said elongated section and said compliant section; and
said support section having a larger cross-section than said elongated section.

2. The contact of claim 1, wherein said compliant section has a cat-eye hole in a central portion thereof.

3. The contact of claim 1, wherein said compliant section has opposed rounded outer surfaces.

4. The contact of claim 1, wherein the compliant section has a wall thickness of approximately 0.044 inches.

5. The contact of claim 1, wherein the compliant section has a length of approximately 0.040 inches.

6. The contact of claim 1, wherein said support section has a first end and a second end, said first end having the same width as said compliant section and said second end having the same width as said elongated section.

7. The contact of claim 1, wherein said support section has a rectangular cross-section.

8. The contact of claim 1, wherein a ramp is formed between said elongated section and said support section.

9. The contact of claim 8, wherein said ramp is formed at approximately 15° angle.

10. The contact of claim 1, further comprising a primary portion for retention in an electrical contact.

11. The contact of claim 1, wherein said compliant section is formed of two opposed curved beams.

12. An electrical connector, comprising:
a body for receiving a plurality of electrical contacts;
each of said electrical contacts comprising:
a contact body including an engagement portion for engagement with an electrical connector body;
said contact body having an elongated section, a compliant section and a support section connecting said elongated section and said compliant section; and
said support section having a larger cross-section than said elongated section.

13. The electrical connector of claim 12, wherein said compliant section has a cat-eye hole in a central portion thereof.

14. The electrical connector of claim 12, wherein said compliant section has opposed rounded outer surfaces.

15. The electrical connector of claim 12, wherein the compliant section has a length of approximately 0.040 inches.

16. The electrical connector of claim 12, wherein said support section has a first end and a second end, said first end having the same width as said compliant section and said second end having the same width as said elongated section.

17. The electrical connector of claim 12, wherein said support section has a rectangular cross-section.

18. The electrical connector of claim 12, wherein a ramp is formed between said elongated section and said support section.

19. The electrical connector of claim 14, wherein said ramp is formed at approximately 15° angle.

20. The electrical connector of claim 12, further comprising a primary portion for retention in an electrical contact.

21. The electrical connector of claim 12, wherein said compliant section is formed of two opposed curved beams.

22. The electrical connector of claim 21, wherein said curved beams are spaced apart by approximately 0.010 inches.

23. The electrical connector of claim 12, wherein the plurality of the contacts have sequential mating levels.
